(19) United States
(12) Patent Application Publication
(10) Pub. No.: US 2026/0071062 A1
(43) Pub. Date: Mar. 12, 2026

(54) HNBR CATHODE BINDERS FOR BATTERY CELLS USING y-VALEROLACTONE AS PROCESSING SOLVENT

(71) Applicant: ARLANXEO DEUTSCHLAND GMBH, Dormagen (DE)

(72) Inventor: Sven BRANDAU, Leverkusen (DE)

(73) Assignee: ARLANXEO DEUTSCHLAND GMBH, Dormagen (DE)

(21) Appl. No.: 19/107,445

(22) PCT Filed: Aug. 28, 2023
(86) PCT No.: PCT/EP2023/073509

§ 371 Date: Feb. 27, 2025

(30) Foreign Application Priority Data
Aug. 30, 2022 (EP) 22192995.3

(51) Int. Cl. C08L 23/20; H01M 4/02; H01M 4/62

(52) U.S. Cl. CPC C08L 23/20; H01M 4/622; C08L 2203/20; H01M 2004/028

(57) ABSTRACT

The invention relates to a polymer comprising or essentially consisting of monomer units derived from 1,3-butadiene, acrylonitrile and optionally, methacrylic acid, wherein the weight content of monomer units derived from 1,3-butadiene is at most 65 wt.-%, relative to the total weight of the polymer. The polymer is useful for manufacturing a cathode for a battery cell. The invention further relates to a cathode of a battery cell comprising the polymer as well as to a composition comprising the polymer and γ-valerolactone.

### FIELD OF INVENTION

The invention relates to a polymer comprising or essentially consisting of monomer units derived from 1,3-butadiene, acrylonitrile and optionally, methacrylic acid, wherein the weight content of monomer units derived from 1,3-butadiene is at most 65 wt.-%, relative to the total weight of the polymer. The polymer is useful for manufacturing a cathode for a battery cell. The invention further relates to a cathode of a battery cell comprising the polymer, as well as to a composition comprising the polymer and γ-valerolactone.

### BACKGROUND OF INVENTION

A rechargeable battery (also known as a storage battery, a secondary cell or an accumulator) is a type of electrical battery which can be charged, discharged and recharged many times. The battery cell comprises electrodes (anode and cathode), an electrolyte and a separator. Within the electrodes, a polymeric binder typically holds active material and conductive material. The binder needs to be flexible and insoluble in the electrolyte. It should provide good adherence to a current collector and have chemical as well as electrochemical stability. Further, it should be applicable to the electrodes in an easy manner.

N-Methylpyrrolidone (NMP) is frequently used as a solvent in the production of cathodes. However, NMP is toxic and there is a demand for non-toxic alternatives in order to allow for safer and greener production of battery cells.

Polyvinylidene fluoride polymer (PVDF) is frequently used as a binder in the production of cathodes. However, PVDF has several drawbacks because the fluorine causes corrosion within the rechargeable battery and is inherently unsafe. As the fluorine can form hydrogen fluoride, handling PVDF requires precautionary safety measures. PVDF has a relatively high density and thus increases the weight of the rechargeable battery.

As a non-toxic and green solvent, γ-valerolactone has been suggested replacing NMP. However, PVDF is barely soluble in γ-valerolactone and additional efforts and elevated temperatures are required to prepare a cathode slurry and electrode. Such solutions of PVDF at high temperatures in γ-valerolactone tend to create gels at room temperature afterwards when the solutions are cooled down.

V. R. Ravikumar et al., ACS Appl. Energy Mater. 2021, 4, 1, 696-703 relates to γ-valerolactone as an alternative solvent for manufacturing of lithium-ion battery electrodes.

JP 2017 045611 A relates to an all-solid type secondary battery that includes an anode active material layer, a solid electrolyte layer and a cathode active material layer in this order. Among many others γ-valerolactone is mentioned as a solvent for the anode active material layer having a boiling point in the range of 180-300° C.

JP 2018 076417 A relates to a porous membrane, which can be used as a separator and is produced with a porous membrane forming composition containing hydrophobically modified, insulating fibres (A), a binder resin (B), and a solvent (S). Among many others γ-valerolactone is mentioned as a solvent (S).

WO 2015 073745 A2 relates to a battery that includes a first conductive substrate portion having a first face, and a second conductive substrate portion having a second face opposed to the first face. Among many others γ-valerolactone is mentioned as a solvent that is useful for preparing the cathode.

WO 0045452 A1 relates to a binder composition for electrode for lithium-ion secondary battery. Among many others γ-valerolactone is mentioned as an organic dispersion medium.

WO 2014 046521 A1 relates to a method of manufacturing a separator for a lithium secondary battery comprising: a step of forming a porous coating layer including inorganic particles on at least one side of a porous substrate; a charging step for forming charged polymer particles by charging polymer particles; a transferring step for transferring the charged polymer particles to an upper surface of the porous coating layer to form a functional coating layer; and a fixing step for fixing the functional coating layer by heat and pressure; a separator manufactured by the method, and a lithium secondary battery including the separator. Among many others γ-valerolactone is mentioned as a nonaqueous electrolyte.

US 2020 0194837 A1 relates to an additive for a lithium secondary battery. Among many others γ-valerolactone is mentioned as an electrolyte.

EP 3 605 675 A1 discloses a polymer and its use as a binder. The polymer contains a conjugated diene monomer unit (e.g. 1,3-butadiene) and/or an alkylene structural unit and a nitrile group-containing monomer unit (e.g. acrylonitrile) and optionally other repeating units (e.g. (meth)acrylic acid ester monomers, such as n-butyl acrylate). The polymer is used together with PVDF as binder.

There is a need for polymers that can be used as cathode binders and that have advantages compared to the polymers of the prior art.

It is an object of the invention to provide battery cells and cathodes thereof that have advantages compared to the prior art, especially with regard to safety and environmental issues. The polymers should overcome the drawbacks of PVDF and should be compatible with safer and greener solvents, especially γ-valerolactone, in order to overcome the drawbacks of NMP.

### SUMMARY OF INVENTION

This object has been achieved by the subject-matter of the patent claims.

The invention relates to a polymer which comprises or essentially consists of monomer units derived from 1,3-butadiene, acrylonitrile and optionally, methacrylic acid, wherein the weight content of monomer units derived from 1,3-butadiene is at most 65 wt.-%, relative to the total weight of the polymer.

It has been surprisingly found that such polymer has a high electrochemical stability and can be readily dissolved in the non-toxic and green solvent γ-valerolactone at room temperature. Those binder solutions can be further processed at room temperature to obtain cathode slurries and cathodes which show very good electrochemical performance and stability. Preferably, the slurries are LFP based.

Aspects the invention relate to the use of the polymer as a binder in a cathode of a battery cell, to a cathode of a battery cell comprising said polymer, and to a composition comprising said polymer and γ-valerolactone.

The polymer provides an at least suitable alternative to the cathode binders of the prior art whilst overcoming the need to use polyvinylidene fluoride (PVDF) and N-methyl pyrrolidone (NMP).

The polymer and a cathode binder made from the polymer is free of PVDF thereby overcoming safety issues and issues with respect to corrosion during manufacture and use in battery applications.

The polymer exhibits at least the same or superior binder properties compared to conventional cathode binders based on PDVF.

The polymer has a lower density compared to PDVF and due to its reduced weight is favourable in portable devices or electric vehicles using a rechargeable battery.

When used as a cathode binder, the polymer maintains capacity retention after being charged, discharged and recharged.

The polymer can be advantageously processed with γ-valerolactone as a solvent in the manufacture of cathodes for battery cells thereby avoiding the need of NMP. Binder solutions of polymer in γ-valerolactone can be prepared at room temperature allowing for smooth processing and preparation of electrodes. Electrochemical evaluation of the cathodes shows a high capacity and stability.

### DETAILED DESCRIPTION

For a complete understanding of the present invention and the advantages thereof, reference is made to the following detailed description. It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

The polymer according to the invention comprises or essentially consists of monomer units derived from 1,3-butadiene, acrylonitrile and optionally methacrylic acid, wherein the weight content of monomer units derived from 1,3-butadiene is at most 65 wt.-%, relative to the total weight of the polymer.

It has been surprisingly found that a maximum content of 1,3-butadiene, i.e. a minimum content of polar monomers including acrylonitrile and optionally methacrylic acid, provides good solubility in γ-valerolactone as well as performance as binder in electrodes.

The term “monomer units” means that a structural unit derived from that monomer is incorporated in the polymer backbone which is obtained by polymerizing that monomer. A skilled person recognizes that polymerization changes the monomer structure and such change is expressed by the term “derived from”. Further, as the polymer according to the invention is preferably hydrogenated, such hydrogenation may further change the monomer unit derived from that monomer. In particular, radical polymerization of 1,3-butadiene using suitable catalysts results in monomer units still having ethylenic unsaturations that upon subsequent hydrogenation are fully or partially saturated.

To be fully hydrogenated, residual double bonds are <1%, to be partially hydrogenated, residual double bonds are <5%.

Preferably, the polymer is hydrogenated. Preferably, the content of residual C═C double-bonds is at most 5%, more preferably at most 4%, relative to the content of C═C double-bonds before hydrogenation. Hydrogenation is preferably performed under conditions that do not essentially affect acrylonitrile and optionally present methacrylic acid.

Preferably, the polymer has a weight content of monomer units derived from 1,3-butadiene within the range of from 55 to 65 wt.-%, relative to the total weight of the polymer.

Preferably, the polymer has a weight content of monomer units derived from acrylonitrile of at least 25 wt.-%, relative to the total weight of the polymer. Preferably, the polymer has a weight content of monomer units derived from acrylonitrile within the range of from 30 to 45 wt.-%, relative to the total weight of the polymer.

Preferably, relative to the total weight of the polymer, the polymer has a weight content of monomer units derived from 1,3-butadiene is within the range of from 55 to 65 wt.-%; and a weight content of monomer units derived from acrylonitrile is within the range of from 35 to 45 wt.-%.

In preferred embodiments, the polymer does not comprise monomer units derived from methacrylic acid. Preferably, the polymer essentially consists of monomer units derived from 1,3-butadiene and acrylonitrile (copolymer, bipolymer).

In other preferred embodiments, the polymer additionally comprises monomer units derived from methacrylic acid. Preferably, the polymer essentially consists of monomer units derived from 1,3-butadiene, acrylonitrile and methacrylic acid (terpolymer).

Preferably, the polymer has a weight content of monomer units derived from methacrylic acid of at least 2.5 wt.-%, relative to the total weight of the polymer. Preferably, the polymer has a weight content of monomer units derived from methacrylic acid within the range of from 2.5 to 7.5 wt.-%, relative to the total weight of the polymer.

Preferably, relative to the total weight of the polymer, the polymer has a weight content of monomer units derived from 1,3-butadiene is within the range of from 55 to 65 wt.-%; a weight content of monomer units derived from acrylonitrile is within the range of from 30 to 45 wt.-%; and a weight content of monomer units derived from methacrylic acid is within the range of from 2.5 to 7.5 wt.-%.

Preferably, the polymer has a Mooney viscosity (ML 1+4 @100° C.) within the range of from 45 to 100 MU, more preferred from 55 to 90 MU, most preferred from 60 to 70 MU.

In a preferred embodiment, the polymer essentially consists of monomer units derived from the following monomers at the following contents, relative to the total weight of the polymer: 1,3-butadiene 62±2 wt.-%, acrylonitrile 33±2 wt.-%, and methacrylic acid 5±2 wt.-% (see example C below).

In a preferred embodiment, the polymer essentially consists of monomer units derived from the following monomers at the following contents, relative to the total weight of the polymer: 1,3-butadiene 61±2 wt.-%, and acrylonitrile 39±2 wt.-% (see example E below).

In a preferred embodiment, the polymer essentially consists of monomer units derived from the following monomers at the following contents, relative to the total weight of the polymer: 1,3-butadiene 57±2 wt.-%, and acrylonitrile 43±2 wt.-% (see example F below).

The polymer according to the invention is related to different aspects of the invention.

A first aspect of the invention relates to the use of the polymer as a binder in a cathode of a battery cell.

A second aspect of the invention relates to a cathode of a battery cell comprising the polymer.

A third aspect of the invention relates to a composition for manufacturing a cathode of a battery cell, said composition comprising (i) the polymer and (ii) γ-valerolactone.

A method for the manufacture of the polymer is not limited and the method can be according to methods known in the art. The method for the manufacture of the polymer can be any of solution polymerisation, suspension polymerisation, bulk polymerisation and emulsion polymerisation. The method for the manufacture of the polymer may be radical polymerisation and living radical polymerisation.

A method for the manufacture of the hydrogenated polymer is likewise not limited. The method for the manufacture of the hydrogenated polymer can be any one of an oil-layer hydrogenation or a water-layer hydrogenation. A homogeneous or heterogeneous hydrogenation catalyst used in the manufacture of the hydrogenated polymer may be any hydrogenation catalyst known in the art, such as a palladium-based catalyst, ruthenium-based catalyst and a rhodium-based catalyst or any combination thereof.

When the polymer is used as cathode binder for a rechargeable battery, the binder holds active material and conductive material within a cathode of the rechargeable battery. The polymer is then dissolved and/or dispersed in an organic solvent to form a binder solution, whereas γ-valerolactone is preferably used as solvent.

The polymer can be ground prior to being dissolved and/or dispersed using a ball mill, a sand mill, a bead mill, a pigment disperser, a grinding machine, an ultrasonic disperser, a homogeniser, a planetary mixer. Such devices can also be used to facilitate the dissolving and and/or dispersing the polymer in the organic solvent to form the binder solution.

The binder solution is then preferably mixed with active material and conductive material to form a cathode slurry composition.

The active material can be a lithium nickel manganese cobalt oxide (abbreviated as Li-NMC, LNMC, NMC or NCM), which is a mixed metal oxides of lithium, nickel, manganese and cobalt. The active material can be a lithium iron phosphate (LFP). The active material can be a lithium manganese oxide (LMO). Lithium iron phosphate (LFP) is preferred.

The conductive material can be carbon materials such as carbon black (e.g. acetylene black, furnace black), graphite (graphene), carbon fibres (carbon nanofibres, single- or multi wall carbon nanotubes (CNTs) and vapour-grown carbon fibres) and carbon flakes.

The cathode slurry composition is then preferably applied to a current collector and then dried.

The application to the current collector can be by doctor blading, dip coating, reverse roll coating, direct roll coating, gravure coating, extrusion coating, bar coater and brush coating. A thickness of the cathode slurry composition on the current collector after application but before drying may be set as appropriately.

The current collector is a material having electrical conductivity and electrochemical durability. The current collector can be made of iron, copper, aluminium, nickel, stainless steel, titanium, tantalum, gold or platinum. The current collector can be in the form of a foil. The current collector is preferably aluminium foil due to its high conductivity, electrochemical and chemical stability and low cost.

Drying of the cathode slurry composition applied to at least one surface of a current collector is preferably achieved by warm, hot, or low humidity air at ambient pressure; drying in a vacuum, drying by irradiation with infrared light or drying with electron beams can also be used.

Following drying, the cathode slurry composition applied to the current collector may be pressed, by mould pressing or roll pressing. The pressing provides a more uniform layer of the dried material.

The resultant positive cathode, comprising the polymer as positive cathode binder is then assembled to form the rechargeable battery.

The rechargeable battery is assembled, preferably by stacking the positive cathode and a negative electrode with a separator in-between, rolling or folding the resultant stack can be necessary in accordance with a shape of the rechargeable battery to place the stack in a battery vessel, filling the battery vessel with an electrolytic solution and then sealing the battery vessel.

In order to prevent pressure increase inside the rechargeable battery and occurrence of over-charging or over-discharging, an overcurrent preventing device such as a PTC device or a fuse; an expanded metal (such as a nickel sponge); or a lead plate can be provided as necessary.

The shape of the rechargeable battery may for example be a coin type, button type, sheet type, cylinder type, prismatic type, pouch type or flat type.

The negative electrode may be any known negative electrode, for example carbon materials such as amorphous carbon, natural graphite, artificial graphite, natural black lead, mesocarbon microbead pitchbased carbon fibre and silicon-graphite; a conductive polymer such as polyacene or polyaniline; or a metal such as silicon, tin, zinc, manganese, titanium oxide, iron, lithium (for half cells) and nickel including an alloy of the metal. The negative electrode is preferably graphite or silicon-graphite.

The separator can be a fine porous membrane or a nonwoven fabric comprising polyamide resins. The fine porous membrane can be made of a polyolefin resin (polyethylene, polypropylene, polybutene, or polyvinyl chloride). The polyolefin resin is preferred since such a separator membrane can reduce a total thickness of the separator, which increases the ratio of the active material and conductive material in the rechargeable battery and ultimately a size of the rechargeable battery.

The electrolytic solution is a solution of supporting electrolyte that is dissolved in an organic solvent.

The supporting electrolyte is a lithium salt, such as LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi and (C₂F₅SO₂)NLi. LiPF6 is preferable as it readily dissolves in a solvent and exhibits a high degree of dissociation. The organic solvent can carbonates such as dimethyl carbonate (DMC), ethylene carbonate (EC), fluoroethylene carbonate (FEC), diethyl carbonate (DEC), propylene carbonate (PC), butylene carbonate (BC), and methyl ethyl carbonate (EMC); esters such as γ-butyrolactone and methyl formate; ethers such as 1,2-dimethoxyethane and tetrahydrofuran; and sulphur-containing compounds such as sulfolane and dimethyl sulfoxide.

### EXAMPLES

The present invention is demonstrated by the following non-limiting examples.

The following materials where used as provided:
Monomer units acrylonitrile, methacrylic acid from Sigma-Aldrich, 1,3-butadiene from INEOS.
Solution Fe(II)SO₄: Premix solution contains 0.986 g Fe(II)SO₄*7 H2O and 2.0 g Rongalit® C in 400 g water.
EDTA: as complexing agent from Sigma-Aldrich.
Fatty acid: CAS 67701-08-8, emulsifier for polymerisation.
SDS: Sodium dodecyl sulphate CAS 151-21-3, emulsifier for polymerisation.
t-DDM: Molecular weight regulator from Arlanxeo Deutschland GmbH.
Trigonox® NT50, p-menthane hydroperoxide from Akzo-Degussa. Initiator for emulsion polymerisation.
Diethylhydroxylamine: polymerisation terminator, CAS 3710-84-7.
Dry monochlorobenzene (MCB) from VWR.
Wilkinson catalyst from Materia Inc. and triphenylphosphine from VWR as hydrogenation catalyst γ-valerolactone (GVL) from Sigma-Aldrich.
Solef® 5130 as polyvinylidene fluoride resin with a molecular weight of 1300 kDa
Kynar® HSV 900 as polyvinylidene fluoride resin with melt viscosity (230° C., 100 s⁻¹) of 48-52.5 kPoise
Lithium iron phosphate: active material; A8-4E, from Hubei Wanrun New Energy Technology Co., LTD.
Conductive carbon black: conductive material; Super C65; from Imerys Graphite & Carbon.
Aluminium foil: current collector; thickness 20 μm; from China Aluminium Shanxi New Material Co.
Lithium disc: anode; ø16 mm from China Energy Lithium Co., Ltd.
Porous polyolefin film: as separator, thickness 38 μm (Celgard® 2340), punched into ø18 mm disc; from Celgard.
Electrolytic solution supporting electrolyte LiPF₆ (Aldrich). Electrolytic solution: 1M in EC/EMC mixture, EC/EMC=30/70 (v/v) with 2 wt % VC. Ethylene carbonate (EC), Ethyl methyl carbonate (EMC) and Vinylene carbonate (VC): organic solvent used for the electrolytic solution.
Battery vessel: coin cell: casing; 2032 type from ShanXi LiZhiYuan Battery Material Co.
Overcurrent preventing device: nickel sponge: thickness of 1 mm per layer, for each coin cell 4 layers were used, from Changsha LiYuan New Material Co.
3M tape: vinyl electrical tape (width of 17.5 mm) from 3M China Company.

### Test Methods

### Acrylonitrile Content:

The nitrogen content for determination of the acrylonitrile content was determined according to Kjeldahl (DIN 53 625).

### Solubility:

The samples were dissolved according to the following procedure, and their solubility evaluated using the succeeding criteria.

A sample is placed at given concentration in the given solvent and shaken at room temperature at 150 rpm using a IKA shaker KS 4000i control. After a given time the samples were subjected to visual assessment.
−− Sample is not dissolved
− Sample starts to be dissolved, swollen particles and most of sample remaining undissolved
0 Sample starts to be dissolved, particles remaining undissolved
+ Most of sample is dissolved, small residuals or partial cloudiness
++ Sample is fully dissolved and does not show any residuals

### Mooney Viscosity:

The values of the Mooney viscosity (ML 1+4@100° C.) are determined in each case by means of a shearing disc viscometer to DIN 53523/3 or ASTM D 1646 at 100° C.

### NMR:

The microstructure and the termonomer content of the individual polymers are determined by means of 1H NMR (instrument: Bruker DPX400 with XWIN-NMR 3.1 software, measurement frequency 400 MHz, solvent CDCl₃).

### Method of Evaluating Discharging Specific Capacity:

The produced secondary battery was charged at 0.1 C rate at 23° C. until the battery voltage reached 4.0 V. Subsequently after 20 minutes, at 23° C., a constant current discharge was performed at 0.1 C rate until the battery voltage reached 2.8 V. The coin cell secondary battery was charged and discharged thereafter in constant current mode (CC mode 0.5 C rate). Between every cycle, there the cell is rested for 5 min. The discharging specific capacity of the secondary battery was calculated as the average value between 2 and 5 cycles.

### Method of Evaluating Capacity Retention:

The coin cell secondary battery was charged and discharged in constant current mode (CC mode 0.2 C rate) for 50 cycles. Capacity retention was determined as the ratio of the discharge specific capacity after 50 cycles over the discharge specific capacity after the second cycle in percent.

### Preparation of Inventive and Comparative Polymers

Hydrogenated butadiene-acrylonitrile copolymers and hydrogenated butadiene-acrylonitrile-methacrylic acid terpolymers were produced according to the base formulation specified in Table 1, with all feedstocks stated in parts by weight based on 100 parts by weight of the monomer mixture. Table 1 also specifies the respective polymerisation conditions.

TABLE 1
Components used for the manufacture of acrylonitrile butadiene rubber copolymers C to I

| Ingredients (phm) | C | D | E | F | G | H | I |
|---|---|---|---|---|---|---|---|
| 1,3-butadiene | 59 | 65 | 57 | 47 | 65 | 76 | 80 |
| acrylonitrile | 36 | 35 | 43 | 53 | 35 | 20 | 20 |
| methacrylic acid | 5 | 0 | 0 | 0 | 0 | 4 | 0 |
| water | 220 | 220 | 220 | 220 | 220 | 220 | 220 |
| fatty acid | — | 1.8 | 1.8 | 1.8 | 1.8 | — | — |
| sodium dodecyl sulphate | 2.6 | — | — | — | — | 2.5 | 2.5 |
| pH (±0.5) | 10.5 | 10.5 | 10.5 | 10.5 | 10.5 | 11.5 | 11.5 |
| t-DDM | 0.5 | 0.5 | 0.5 | 0.7 | 0.5 | 0.6 | 0.6 |
| Trigonox ® NT 50 | 0.01 | 0.04 | 0.04 | 0.04 | 0.04 | 0.02 | 0.02 |
| solution Fe(II)SO₄ | 0.01 | 0.04 | 0.04 | 0.04 | 0.04 | 0.02 | 0.02 |
| diethylhydroxylamine | 0.2 | 0.2 | 0.2 | 0.2 | 0.2 | 0.8 | 0.8 |
| polymerisation temp (±1° C.) | 8 | 13 | 13 | 13 | 13 | 12 | 12 |
| conversion (%) | 83 | 73 | 75 | 78 | 73 | 75 | 75 |
| hydrogenation catalyst | 0.04 | 0.07 | 0.07 | 0.07 | 0.07 | 0.04 | 0.07 |
| metathesis performed | no | no | no | no | yes | no | no |

Polymers were produced batchwise in a 5 L autoclave with stirrer system. In each of the autoclave batches, 1.25 kg of the monomer mixture and a total amount of water of 2.1 kg was used, as was EDTA in an equimolar amount based on the Fe(II). 1.9 kg of this amount of water were initially charged with the emulsifier in the autoclave and purged with a nitrogen stream. Thereafter, the destabilized monomers and t-DDM (tert-dodecylmercaptane) as molecular weight regulator were added and the reactor was closed. After the reactor contents had been brought to temperature, the polymerisations were started by the addition of the Fe(II)SO₄ premix solution and of para-menthane hydroperoxide (Trigonox® NT50).

The course of the polymerisation was monitored by gravimetric determinations of conversion. On attainment of the conversions reported in Table 1, the polymerisation was stopped by adding an aqueous solution of diethylhydroxylamine. Unconverted monomers and other volatile constituents were removed by means of steam distillation.

An antioxidant was mixed with a dispersion of the polymer and adjusted to solid content of 17.5% by weight. Afterwards the resulting dispersion comprising the additional anti ageing components was subjected to coagulation by the addition of calcium salts or by the addition of an acid to decrease the pH value, washed, dewatered and dried according to a procedure known in the art.

The following hydrogenations were carried out in a 10 L high pressure reactor under the following conditions. For this purpose, the polymers were dissolved in monochlorobenzene (MCB) at a given solid content:
Solids concentration: 12-13% by weight of polymer in MCB
Reactor temperature: 137-140° C.
Reaction time: up to 4 hours
Catalyst: Wilkinson catalyst, triphenylphosphine as co-catalyst
Hydrogen pressure: 8.4 MPa
Stirrer speed: 600 rpm

The polymer solution was degassed 3 times with H₂ (23° C., 2 MPa) with vigorous stirring. The temperature of the reactor was raised to 100° C. and the H₂ pressure to 6 MPa. A monochlorobenzene solution consisting of Wilkinson catalyst and co-catalyst was added and the pressure was raised to 8.4 MPa while the reactor temperature was adjusted to 137-140° C. The temperature and pressure were kept constant during the reaction. The course of the reaction was monitored by measuring a residual double bond content by means of IR spectroscopy.

The reaction was terminated when the residual double bond content of <5% had been reached by releasing the hydrogen pressure.

The resulting hydrogenated polymers were isolated from the solution by steam coagulation. For this, the monochlorobenzene solution was diluted to a polymer content of 7% by weight and metered continuously into a stirred glass reactor which was filled with water and preheated to 100° C. At the same time, 0.5 bar steam was used for introduction into the coagulation water. The polymer precipitated as crumbs were dewatered and then dried at 55° C. under vacuum.

The composition of the respective hydrogenated polymers, the monomer unit content, % of residual double bonds and Mooney viscosity are shown in Table 2.

The spectrum of polymers before, during and after the hydrogenation reaction were recorded on a Perkin Elmer spectrum 100 FT-IR spectrometer. A solution of the polymer in monochlorobenzene was cast onto a KBr disk and dried to form a film for the test. The hydrogenation conversion was determined by the FT-IR analysis according to the ASTM D 5670-95 method.

Before the hydrogenation of polymer G, metathesis reaction was done to reduce the molecular weight of the nitrile rubber. Metathesis is known, for example, from WO-A-02/100941 and WO-A-02/100905 and can be used to reduce the molecular weight.

TABLE 2
Properties of polyvinylidene fluoride resins A (Krynar HSV
900) and B (Solef 5130) and of hydrogenated polymers C to I

| copolymer | A | B | C | D | E | F | G | H | I |
|---|---|---|---|---|---|---|---|---|---|
| content 1,3-butadiene [wt.-%] | — | — | 62 | 66 | 61 | 57 | 66 | 71 | 78 |
| content acrylonitrile [wt.-%] | — | — | 33 | 34 | 39 | 43 | 34 | 24 | 22 |
| content methacrylic acid [wt.-%] | — | — | 5 | — | — | — | — | 5 | — |
| content of polar monomers [wt.-%] | — | — | 38 | 34 | 39 | 43 | 34 | 29 | 22 |
| residual double-bonds [%] | — | — | 3.5 | <0.9 | <0.9 | <0.9 | <0.9 | 3.3 | <0.9 |
| Mooney Vis. ML(1 + 4) 100° C., (MU) | ^{a)} | ^{b)} | 77 | 70 | 70 | 63 | 39 | 92 | 107 |
| density [g/cm³] | 1.78 | 1.77 | 0.97 | 0.95 | 0.96 | 0.96 | 0.95 | nd^{c)} | nd^{c)} |

^{a)}Molecular weight: about 1000 kDa;
^{b)}Molecular weight: 1300 kDa;
^{c)}nd: not determined

Polymer C is a terpolymer according to the invention and polymers E and F are copolymers (bipolymers) according to the invention. Polymers A and B are PVDC polymers and thus comparative. Further, copolymers D, G, and I as well as terpolymer H have a content of monomer units derived from 1,3-butadiene exceeding 65 wt.-% and are thus comparative as well.

The results from Table 2 show that the polymers C to G maintain at least a lower density compared to PVDF (polymers A and B).

Polymer samples were dissolved in γ-valerolactone at room temperature and their solubility was evaluated after 90 min. Polyvinylidene fluoride resins A and B did not at all dissolve in γ-valerolactone at room temperature, whereas hydrogenated polymers C, E and F readily dissolved in γ-valerolactone at room temperature thereby leading to an improvement in battery cell productivity and energy savings in the preparation process. Moreover, solubility performance is independent of the molecular weight of the hydrogenated nitrile rubbers.

TABLE 3
Solubility of comparative polyvinylidene fluoride resins A (Krynar
HSV 900) and B (Solef 5130) and of hydrogenated polymers C to I

| polymer | A | B | C | D | E | F | G | H | I |
|---|---|---|---|---|---|---|---|---|---|
| solvent | GVL | GVL | GVL | GVL | GVL | GVL | GVL | GVL | GVL |
| concentration | 5% | 5% | 5% | 5% | 5% | 5% | 5% | 5% | 5% |
| solubility rating [90 min] | −− | − | ++ | −− | ++ | ++ | −− | −− | − |

The results in Table 3 show that hydrogenated polymers with a minimum content of polar monomers (acrylonitrile and optionally methacrylic acid) have a good solubility in γ-valerolactone at room temperature, while polyvinylidene fluoride resins cannot be dissolved at all. The preparation of a binder solution at room temperature using the non-toxic solvent γ-valerolactone can be therefore managed using the hydrogenated polymers C, E and F replacing toxic battery solvent NMP.

### General Method of Coin Cell Fabrication

Step (1)—Dissolution: A certain amount of the polymer is dissolved in the solvent (γ-valerolactone) in a shaker overnight at room temperature to form a binder solution (8 wt.-%).

Step (2)—Cathode slurry composition preparation: The binder solution from step 1 is mixed with the conductive material (conductive carbon black Super C65) in a thinky mixer (milling conditions: 2000 rpm, 12 minutes, room temperature). Thereafter the active material (LFP, C-coated, A8-4E) and half solvent (γ-valerolactone) is added (milling conditions: 2000 rpm, 18 minutes, room temperature), finally the remaining solvent (γ-valerolactone) is added (milling conditions: 2000 rpm, 6 minutes, room temperature) to obtain the cathode slurry composition

TABLE 4
Formulation of battery cell

| formulation | weight ratio (%) |
|---|---|
| binder solution in γ-valerolactone, 8 wt.-% | 25 |
| conductive carbon black (Super C65) | 2 |
| active material (LFP) | 96 |
| γ-valerolactone (remaining solvent) | 44 |

Weight ratio: LFP/polymer/γ-valerolactone/Super C65 = 96/2/67/2 (Polymer concentration in γ-valerolactone = 8 wt.-%) for a total slurry solid content of 60%

Step (3)—Production of the cathode disc: The cathode slurry composition was applied with a bar coater onto a current collector (aluminium foil) using 4.1 mm/s coating speed to form a cathode sheet. The coater slit gap of the coating machine was adjusted to 250 μm to obtain a pre-determined coating thickness.

Step (4)—Drying: The cathode sheet was dried in an oven at 120° C. for 240 minutes to remove solvent and moisture. After drying the cathode sheet was compressed with a hot press first and then calandered with a 2-roll device until dried thickness is reduced by 20% and to adjust the areal density. From the calandered cathode sheet a cathode disc (o 16 mm) was punched using a machine from Shenzhen Poxon Machinery Technology Co., Ltd. Model: PX-CP-S2, Model: PX-CP-S2. The punch edge was sharp without burr.

Step (5)—Assembly of the lithium-ion secondary battery: Assembly and pressing of the lithium-ion secondary battery is carried out in a glove box. The assembly comprises the coin cell casing top (2032 type; negative side), support (stainless steel spacer×2 & spring), the lithium disc (as anode), the porous separator (Celgard 2400), the cathode disc and the casing bottom (positive side). All parts were assembled layer-by-layer. The electrolyte solution (140 μL 1M/L LiPF6 in EC/EMC=30/70 (v/v) with 2 wt % VC) was dropped in during the assembly step in order to completely fill the free volume of the coin cell. Finally, the coin cell case was pressed by the press machine in the glovebox. An open-circuit voltage test was performed to check, whether short-circuit took place or not.

TABLE 5
Determination of the discharging specific capacity and the capacity
retention of the lithium-ion battery (examples A, C-F)

| Copolymer | A | C | D | E | F |
|---|---|---|---|---|---|
| discharging specific capacity [mAh/g] | np^{a)} | 140 | np^{a)} | 136 | 139 |
| capacity retention after 50 cycles | np | 98 | np | 100 | 98 |

^{a)}np: not possible to determine as no electrodes can be prepared based on the non or bad solubility in γ-valerolactone

The results in Table 5 show that the use of fluorine-free hydrogenated polymers C, E and F lead to a high specific capacity maintaining a good capacity retention using a non-toxic solvent for battery processing. It is therefore possible to replace the toxic battery solvent NMP and by using the inventive nitrile rubbers to obtain battery cells with a high capacity and capacity retention.

Having thus described the present invention and the advantages thereof, it should be appreciated that the various aspects and embodiments of the present invention as disclosed herein are merely illustrative of specific ways to make and use the invention.

The various aspects and embodiments of the present invention do not limit the scope of the invention when taken into consideration with the appended claims and the foregoing detailed description.

What is desired to be protected by letters patent is set forth in the following claims.

1. A composition comprising:
(i) a polymer comprising or essentially consisting of monomer units derived from:
1,3-butadiene,
acrylonitrile and
optionally, methacrylic acid,
wherein a weight content of monomer units derived from 1,3-butadiene is at most 65 wt.-%, relative to a total weight of the polymer; and
(ii) γ-valerolactone.

2. A composition according to claim 1, wherein the polymer is hydrogenated.

3. A composition according to claim 2, wherein a content of residual C═C double-bonds of the polymer is at most 5%, relative to a content of C═C double-bonds before hydrogenation.

4. A composition according to claim 1, wherein the polymer has a weight content of monomer units derived from 1,3-butadiene within the range of from 55 to 65 wt.-%, relative to the total weight of the polymer.

5. A composition according to claim 1, wherein the polymer has a weight content of monomer units derived from acrylonitrile of at least 25 wt.-%, relative to the total weight of the polymer.

6. A composition according to claim 1, wherein the polymer has a weight content of monomer units derived from acrylonitrile within the range of from 30 to 45 wt.-%, relative to the total weight of the polymer.

7. A composition according to claim 1, wherein relative to a total weight of the polymer, the polymer has:
a weight content of monomer units derived from 1,3-butadiene within the range of from 55 to 65 wt.-%; and
a weight content of monomer units derived from acrylonitrile within the range of from 35 to 45 wt.-%.

8. A composition according to claim 1, wherein the polymer does not comprise monomer units derived from methacrylic acid.

9. A composition according to claim 1, wherein the polymer has a weight content of monomer units derived from methacrylic acid of at least 2.5 wt.-%, relative to the total weight of the polymer.

10. A composition according to claim 9, wherein the polymer has a weight content of monomer units derived from methacrylic acid within the range of from 2.5 to 7.5 wt.-%, relative to the total weight of the polymer.

11. A composition according to claim 9, wherein relative to the total weight of the polymer, the polymer has:
a weight content of monomer units derived from 1,3-butadiene within the range of from 55 to 65 wt.-%;
a weight content of monomer units derived from acrylonitrile within the range of from 30 to 45 wt.-%; and
a weight content of monomer units derived from methacrylic acid within the range of from 2.5 to 7.5 wt.-%.

12. A composition according to claim 1, wherein the polymer essentially consists of monomer units derived from the following monomers at the following contents, relative to the total weight of the polymer:
(i) 1,3-butadiene 62±2 wt.-%, acrylonitrile 33±2 wt.-%, and methacrylic acid 5±2 wt.-%;
(ii) 1,3-butadiene 61±2 wt.-%, and acrylonitrile 39±2 wt.-%; or
(iii) 1,3-butadiene 57±2 wt.-%, and acrylonitrile 43±2 wt.-%.

13. (canceled)

14. Cathode of a battery cell obtained from a composition according to claim 1.

15. A rechargeable battery comprising a battery cell comprising a cathode according to claim 14.

16. A battery-powered device comprising the rechargeable battery according to claim 15.
